(19) United States
(12) Patent Application Publication
(10) Pub. No.: US 2006/0242219 A1
(43) Pub. Date: Oct. 26, 2006

(54) Asynchronous multiplier

(76) Inventors: Chin-Yung Chen, Taoyuan (TW); Kuang-Shyr Wu, Taoyuan Hsien (TW)

Correspondence Address: J C PATENTS, INC., 4 VENTURE, SUITE 250, IRVINE, CA, 92618, US

(21) Appl. No.: 11/111,080

(22) Filed: Apr. 20, 2005

(51) Int. Cl. G06F 7/52

(52) U.S. Cl. 708/620

(57) ABSTRACT

An asynchronous multiplier is provided. The multiplier comprises a partial product generator, an addition array, a leading-zero-bit detector, a final-stage adder and a completion detector. The partial product generator generates a plurality of partial products, and the addition array adds these partial products. The leading-zero-bit detector detects effective bits of the multiplicand and the multiplier, and outputs a set of detection signals so that the adder of the addition array determines either to output zero or perform addition operation. Then, the final-stage adder adds these partial products and outputs a sum. Finally, the completion detector checks and outputs the result.

### BACKGROUND OF THE INVENTION

1. Field of the Invention

The present invention relates to an asynchronous multiplier, and more particularly to an asynchronous multiplier with an accelerating circuit.

2. Description of the Related Art

The multiplier is an essential device in apparatuses such as micro-processors or in digital signal processing, and discrete sine transform. Multipliers usually take the longest operational time, which usually is the decisive factor of an effective chip. For the time being, several synchronous designs have been proposed, and so are the asynchronous designs. Due to its low power-consumption, low average operational time and flexibility to adapt to various process and environment, the asynchronous circuit has been used in very large scale integrated (VLSI) circuits for better performance.

Generally, the current multipliers comprise right-to-left array multipliers, left to right multipliers, divided array multipliers and multi-select array multipliers.

In the conventional technology, a right-to-left array multiplier has the most simple connection and rules, and thus becomes one of the most popular structures. FIG. 1A is a schematic drawing showing a conventional right-to-left carry-ripple array multiplier. FIG. 1B is a schematic drawing showing a right-to-left carry-save array multiplier. Referring to FIGS. 1A and 1B, the right-to-left array multiplier 100 comprises a partial product generator (PPG) 102, a right-to-left addition array 104, and a final-stage adder 108. In FIG. 1A, “●”represents a bit product generation. The PPG 102 is usually implemented with AND gate. “⊕” represents an adder. In the right-to-left array adder 100, the sum of each adder 104 is propagated to the next-stage adder 104. The carry of each adder 104 is propagated to the higher-bit adder 104 in the same stage.

For the n-bit multiplicand and the n-bit multiplier, the area of the right-to-left carry-ripple array multiplier 100 is:
A_{R-L-CAR}=A_{PPG}+A_{CRA-array} (1)
A_{PPG}=n²Ahd AND2 (2)
A_{CRA-array}=(n−1) ²A_{FA}+(n−1) A_{HA} (3)

Wherein, A_{PPG} represents the area of PPG102. A_{AND2} represents the area of the two input AND gates. A_{CRA-array} represents the area of the carry-ripple addition array 104. A_{FA} represents the area of the full adder. A_{HA} represents the area of the half adder.

Referring to FIG. 1B, a conventional carry-save addition array multiplier 120 is shown. The carries generated by these adders are passed down to the next stage of the array and thus there is no need to wait for a carry chain to propagate across one stage before beginning the computation of the next.

With the n-bit multiplicand and the n-bit multiplier, the area of the right-to-left carry-save array multiplier 120 is:
A_{R-L-CSA}=A_{PPG}+A_{CSA-array}+A_{final-stag-add} (4)
A_{PPG}=n²A_{AND2} (5)
A_{CRA-array}=(n−1) (n−2) A_{FA+}(n−1) A_{HA} (6)
A_{final-stag-add}=A_{n-bit-adder} (7)

Wherein, A_{final-stag-add} represents the area of the final-stage adder 108, and the area depends on the implementation of the addition structure. In addition, in these equations, the right-to-left PPG and the left-to-right PPG have the same area. Considering the area of the addition array, CSA is smaller than CRA, but CSA needs additional final-stage adder.

For the design of a synchronous multiplier, the time for executing the addition array 104 with the save-carry adder 120 is less than that for executing the addition array 104 with the carry-ripple adder 100. The delay can be reduced from (2n−2) t_{F A} to (n−1)t_{F A}, and t_{F A} represents a delay for each bit full adder.

FIG. 2A is a schematic drawing showing a conventional 8×8 left-to-right carry-ripple array multiplier. FIG. 2B is a schematic drawing showing a conventional 8×8 left-to-right carry-save array multiplier. Referring to FIGS. 2A and 2B, the left-to-right array multipliers 200 and 220 comprise the PPGs 202, the right-to-left addition arrays 204 and the final-stage adders 206. The difference between the R-L multiplier and the L-R multiplier is in the addition array 204 and the final-stage adder 208. In the right-to-left addition array 204, the least-significant-bit partial product (LSBPP) is added, and the sum and carry are passed down to the next higher significant bit for addition. Accordingly, the most-significant-bit partial product (MSBPP) is added until the minimum adder. On the contrary, for the left-to-right addition array, the MSBPP is added first. The result is then propagated to the less significant bit. The step is repeated until the LSBPP is added.

The area of the L-R carry-ripple array multiplier 200 is:
A_{L-R-CRA}=A_{PPG}+A_{CRA-array}+A_{final-stag-add} (8)
A_{PPG}=n² A_{AND2} (9)
A_{CRA-array}=(n−1) (n−2) A_{FA}+(n−1) A_{HA} (10)
A_{final-stag-add}=A_{n-bit-adder} (11)

As shown in FIG. 2B, the final-stage addition comprises (2n−1) bits. The gray “⊕” represents the only additional hardware of the L-R multiplier. The gray “⊕” is at the final row to add the left-half carry sum vector to the final sum vector. The area of the L-R carry-save array multiplier 220 is:
A_{L-R-CSA}=A_{PPG}+A_{CSA-array}+A_{final-stag-addy}+A_{EXTRA} (12)
A_{PPG}=n² A_{AND2} (13)
A_{CSA-array}=(n−3) (n−2) A_{F A}+(n−2) A_{HA} (14)
A_{final-stag-add}=A_{2n-bit-adder} (15)
Aₑₓₜᵣₐ=(n−2) A_{F A}

Based on the high-level estimation, the cost of the L-R scheme is similar to that of the R-L scheme. Table 1 shows the cost and delay time of the 32 x 32 R-L multiplier.

TABLE 1

| scheme | | | | | | | |
|---|---|---|---|---|---|---|---|
| | Addi- | Final- | | | Average | | |
| | tion | stage | Cost (logic | | computation | | Cost* |
| No. | array | adder | device) | | time (ns) | | time |
| 1 | R-L | | 13203 | Basic | 69.61 | Basic | Basic |
| | CRA | | | | | | |
| 2 | R-L | CRA | 12379 | −6.24% | 74.06 | 6.39% | −0.25% |
| | CSA | | | | | | |
| 3 | R-L | CLA | 12628 | −4.36% | 62.66 | −9.98% | −13.90% |
| | CSA | | | | | | |
| 4 | R-L | CRA | 12567 | −4.82% | 61.77 | −11.26% | −15.54% |
| | CRA | | | | | | |
| 5 | R-L | CLA | 13142 | −0.46% | 70.06 | 0.65% | 0.19% |
| | CRA | | | | | | |
| 6 | R-L | CRA | 12001 | −9.10% | 64.99 | −6.64% | −15.14% |
| | CSA | | | | | | |
| 7 | R-L | CLA | 12120 | −8.20% | 59.47 | −14.57% | −21.58% |
| | CRA | | | | | | |

The base-line scheme uses the R-L carry-ripple array multiplier 100. The scheme does not need the final-stage adder 106. The second row represents the right-to-left CSA array with the CRA in the final-stage adder 106. It, however, causes the longest delay.

From Table 1, the left-to-right array multipliers 200 and 220 have lower cost and better performance than the right-to-left array multipliers 100 and 120. The array look-ahead adder with the final-stage adder might have slightly more cost, but can reduce more computation time of the adder than the carry-ripple adder.

The left-to-right CSA array with the CLA, such as the final-stage adder, can reduce 8.20% logic cost, and 14.75% computation time. Compared with other scheme, it provides a better cost/performance ratio.

Generally, an array multiplier has a longer transmission route and consumes more power. A solution is to divide the array into two parts. Then, the results are combined at the final stage. Accordingly, the computation time of this scheme can be reduced.

FIG. 3 is a schematic drawing showing a conventional asynchronous array multiplier scheme. Referring to FIG. 3, the asynchronous addition array 300 is divided into a lower array 302, and an upper array 304. It also includes the carry look-ahead adder 306. As shown in FIG. 3, the lower array 302 start adding partial products from the most significant bit of the multiplier, and the upper array 304 start adding partial products from the least significant bit of the multiplier 304. According to the simulation results, there are a lot of leading ‘0s’ in the operands and the partial products are zero. The sum of successive 0 partial products are zero. If the successive 0 partial products can be found earlier, the computation time of the lower array is shorter than that of the upper array 304. In order to obtain better efficiency, the partial products in each array are different.

FIG. 4 is a schematic drawing showing a conventional select multiplier scheme. Compared with the last scheme, the present one does not require the PPG. The select multiplier 400 mainly comprises the data-dependent carry-save addition array 406, and the data-dependent array decomposition adder 408.

The data-dependent carry-save addition array 406 comprises the full adder 412 and the multiplexer 414. When the bit of the multiplier 404Bn is 1, the partial product is equal to the bit of the multiplicand 402An. The full adder 412 adds the inputs (CI, SI and Al) and outputs the carry/sum vector through the multiplexer 414 to the next stage. If the bit of the multiplier 404Bn is 0, the partial products of this row are zero. The full adders 412 of this row do not need to do anything, and the multiplexer simply outputs the carry/sum vector to the next stage.

In the data-dependent carry decomposition area of the multiplexer 404, the sum and the carry are added to obtain the final product. This area must decompose all carries transmitted from the LSB and the MSB. The carry-ripple adder has the smallest carry decomposition area. The carry look-ahead adder can also be selected to reduce time.

In the conventional technology, a delay-insensitive unit (DI) is used in the asynchronous array multiplier. The DI unit usually includes the PPGs, the DI adder, the DI array look-ahead adder and the completion detector.

Except for a few schemes, such as the Kearney and Bergmann data-dependent multiplier, the first unit of most array multiplier is a PPG. The PPG can be defined as below:

$${PP}_{ij} = {\sum }_{i = 0}^{m - 1} {\sum }_{j = 0}^{n - 1} {y}_{i} {x}_{j} {2}^{i + j}$$

Accordingly, a multiplier with m-bit multiplicand and n-bit multiplier requires m*n PPGs to generate m*n-bit products. FIG. 5 is a schematic drawing showing a conventional 8*8-bit product. Each gray point 502 represents a bit product, and each square row of the gray points 502 represents a duplicate partial product 504. Wherein, the duplicate partial product is the product of the multiplicand and a particular bit of the multiplier (xⱼ).

In the conventional multiplier, the least significant partial product is generated at the top of the array. On the contrary, in the left-to-right multiplier, the least significant partial product is generated at the bottom of the array.

The PPG is implemented by the DI AND gate. The logic of the DI AND gate can be defined as:
Q¹←A¹B¹ (18)
Q⁰←A⁰B⁰ (19)

Wherein, (A¹,A⁰) and (B¹,B⁰) are inputs, and (Q¹,Q⁰) is an output. In addition, all signals are executed by the dual-rail signaling. FIG. 6A is a conventional DI AND gate circuit 600 obtained from the equations 18 and 19. FIG. 6B is a schematic drawing showing a conventional DI AND gate 602, and signals are grouped as A=(A¹,A⁰), B=(B¹,B⁰), and Q=(Q¹,Q⁰).

FIG. 7 is a schematic drawing showing a conventional single partial product generator scheme in a single row. Referring to FIG. 7, the gray point 704 represents the partial product, which is the product of the multiplicand and a particular bit of the multiplier (xⱼ). The partial products are added by the addition array.

In the conventional technology, the DI full adder 700 can be a basic unit of the addition array. To execute the DI full adder 702, the dual-rail signal is used for inputting (A⁰,A¹), (B⁰,B¹) and (C⁰,C¹), and outputting the sum (S⁰,S¹) and the carry (Cₒᵤₜ⁰,Cₒᵤₜ¹). Wherein, the sum and the carry can be obtained from the following logic expression:
Cₒᵤₜ⁰=A⁰B⁰+A⁰C⁰+B⁰C⁰
Cₒᵤₜ¹=A¹B¹+A¹C¹+B¹C¹

FIG. 8A is a schematic drawing showing a dual-rail symbol of a conventional DI full adder 800. Referring to FIG. 8A, the dual-rail signals can be represented as A=(A¹,A⁰), B=(B¹, B⁰), C=(C¹,C⁰), S=(S¹,S⁰) and Cₒᵤₜ=(Cₒᵤₜ⁰, Cₒᵤₜ¹). FIG. 8B is a schematic drawing showing a dual-rail symbol of a conventional DI full adder.

The DI full adder 800 can comprise the right-to-left carry-ripple array or the carry-save array of the asynchronous multiplier shown in FIG. 1, or the left-to-right carry-ripple array or the carry-save array of the asynchronous multiplier shown in FIG. 2.

FIG. 9 is a schematic drawing showing a conventional DI carry look-ahead adder. Referring to FIG. 9, the DI carry look-ahead adder (DICLA) 900 is disposed at the final-stage adder. The DICLA 900 comprises the input bits (Ai, Bi), the output bits (Si, Ci) and the hot code (ki, gi, pi) of the internal signal. The DICLA 900 in FIG. 9 is an 8-bit DICLA scheme. The DICLA comprises two basic modules: the C module 902, and the D module 904. In addition, the C module can be shown as:
Carry-kill kᵢ=Aᵢ⁰Bᵢ⁰ (24)
Carry-generate gᵢ=Aᵢ¹Bᵢ¹ (25)
Carry-propagate pᵢ=Aᵢ⁰Bᵢ¹+Aᵢ¹Bᵢ⁰ (26)
Sum⁰ Sᵢ⁰=Aᵢ⁰Bᵢ⁰Cᵢ⁰+Aᵢ¹Bᵢ¹Cᵢ⁰+Aᵢ⁰Bᵢ¹Cᵢ¹+Aᵢ¹Bᵢ⁰Cᵢ¹ (27)
Sum¹ Sᵢ¹=Aᵢ¹Bᵢ¹Cᵢ¹+Aᵢ¹Bᵢ⁰Cᵢ⁰+Aⁱ⁰Bᵢ¹Cᵢ⁰+Aᵢ⁰Bᵢ⁰Cᵢ¹ (28)

Wherein, i=0, 1 . . . , n−2, n−1. As shown in FIG. 9, the input/output signal of the C module 902 can be shown Aᵢ=(Aᵢ⁰, Aᵢ¹), Bᵢ=(Bᵢ⁰, Bᵢ¹), Cᵢ=(Cᵢ⁰, Cᵢ¹), Sᵢ=(Sᵢ⁰, Sᵢ¹), and Iᵢ=(kᵢ, gᵢ, pᵢ).

The D module 904 can be shown as:
Block-carry-propagate P_{i,k}=P_{i,j} P_{j-1,k} (29)
Block-carry-kill K_{i,k}=K_{i,j}+P_{i,j} K_{j-1,k} (30)
Block-carry-generate G_{i,k}=G_{i,j}+P_{i,j} G_{j-1,k} (31)
Block-carry-out Cⱼ¹=K_{j-1,k}+P_{j-1,k}Cₖ⁰ (32)
Block-carry-out Cⱼ¹=G_{j-1,k}+P_{j-1,k}Cₖ¹ (33)

Wherein, i=0, 1, . . . , n−2, n−1. The input/output signals of the D module 904 can be shown I_{i,j}=(K_{i,j}, G_{i,j}, P_{i,j}), and Cᵢ=(Cᵢ⁰, Cᵢ¹).

In the initial state of FIG. 9, all of the outputs (A₁⁰, A₁¹, B₁⁰, B₁¹, C₀⁰ and C₀¹, wherein, i=0, 1 . . . , n−1) are zero. Accordingly, all of the carries (C₁⁰ and C₁¹ wherein, i=1,2 . . . , n) and the internal signals, such as Kij, Gij, and Pij, are zero. During the computation time, the inputs Ai, Bi and C0 become valid, and then the outputs Ci (i=1, . . . , n) and Si (i=1, . . . , n−1) become valid. Finally, the completion detector checks all of the outputs, and outputs the completion signal indicating that the operation is completed.

In the conventional technology, the synchronous circuit uses a clock to synchronize operations of all sub-systems, but not the asynchronous circuit. The asynchronous circuit usually uses the start signal (demand) and the completion signal (response) to synchronize other circuits and itself.

FIG. 10 is a schematic drawing showing a conventional Muller-C element 1002 with two inputs. Referring to FIG. 10, the Muller-C element 1002 executes the complete detection for the self-timed circuit or the DI circuit. In the Muller-C element 1002 with two inputs of FIG. 10, if a=b=0, q=0; and if a=b=1, then q=1, or q is a constant. The table is shown below:

TABLE 2

| a | b | q |
|---|---|---|
| 0 | 0 | 0 |
| 0 | 1 | Unchanged |
| 1 | 0 | Unchanged |
| 1 | 1 | 1 |

N input completion detections can be executed by the two-input C element 1002 so as to build the tree structure shown in FIG. 11. When N is a large number, a great delay will be created.

FIG. 12 is a schematic drawing showing a conventional n-bit completion detector. Referring to FIG. 12, the gate-level execution of an n-input C element 1002 is shown. The functions of done and reset can be defined as:
done=ack₀*ack₁*ack₂* . . . *ackₙ₋₂*ackₙ₋₁ (34)
reset=ack₀+ack₁+ack₂+ . . . +ackₙ₋₂+ackₙ₋₁ (35)

The done function is performed by the n-input AND gate 1004, and the reset function is performed by the n-input OR gate 1006. The two-input C element 1002 is used for combining them. If all ackᵢ are opened, and done=reset=1, then donereset are opened. If all acki are closed, and done=reset=1, then donereset is closed. In addition, if done is not equal to rest, then donerest remains unchanged.

Therefore, if the particular bit of the multiplier is zero, the duplicate partial product of the mapped bit of the multiplier is zero. Its sum and carry vector will be zero until the bit of the multiplier meets 1. If most of the bits of the multiplier are zero, their effective bit length will be shorter than the designed length. Accordingly, the multiplier would have much delay time for calculating these zeros.

Accordingly, a method to resolve the issues described above is desired.

### SUMMARY OF THE INVENTION

Accordingly, the present invention is directed to an asynchronous multiplier, which directly outputs a ineffective bit, i.e., zero, to the final-stage adder to save operational time and enhance the operational speed.

The present invention provides an asynchronous multiplier. The asynchronous multiplier comprises a partial product generator, an addition array, a leading zero-bit detector, a final-stage adder, and a completion detector. The partial product generator generates a plurality of partial products according to a multiplier and a multiplicand. The addition array is coupled to the partial product generator, and performs addition operation to the partial products. The leading zero-bit detector is coupled to the addition array to detect a effective bit of the multiplier and a effective bit of the multiplicand, and to output a set of detection signals. The final-stage adder is coupled to the addition array to add the partial products and to output a sum. The completion detector is coupled to the final-stage adder to check and output the sum.

According to an embodiment of the present invention, the addition array comprises a plurality of zero adders coupled to the partial product generator and the leading zero-bit detector, and determines either to output zero or perform the addition operation according to the set of the detection signals.

According to an embodiment of the present invention, the zero adder comprises a plurality of DI adders and a plurality of DI multiplexers. The DI adders perform an addition operation to each bit of the partial products. The DI multiplexers are coupled to the DI adders, determining either to output zero or perform the addition operation according to the set of the detection signals.

According to an embodiment of the present invention, each of the multiplier and the multiplicand comprises effective bits and a ineffective bit. The multiplier is coupled to the leading zero-bit detector.

According to an embodiment of the present invention, the leading-zero- bit detector detects each bit between a most significant bit and a least significant bit of the multiplier.

According to an embodiment of the present invention, a logic value of the most significant bit is 0.

According to an embodiment of the present invention, the addition array is a left-to right addition array.

The present invention applies the accelerating circuit composed of the leading-zero-bit detector and the zero adders. The effective bits and the ineffective bit of the partial products can be differentiated. The ineffective bit, i.e., 0, is directly output to the final-stage adder to save the operational time and enhance the operational speed.

The above and other features of the present invention will be better understood from the following detailed description of the embodiments of the invention that is provided in communication with the accompanying drawings.

### BRIEF DESCRIPTION OF THE DRAWINGS

FIG. 1A is a schematic drawing showing a conventional right-to-left carry-ripple array multiplier.

FIG. 1B is a schematic drawing showing a right-to-left carry-save array multiplier.

FIG. 2A is a schematic drawing showing a conventional 8×8 left-to-right carry-ripple array multiplier.

FIG. 2B is a schematic drawing showing a conventional 8×8 left-to-right carry-save array multiplier.

FIG. 3 is a schematic drawing showing a conventional asynchronous array multiplier scheme.

FIG. 4 is a schematic drawing showing a conventional select multiplier scheme.

FIG. 5 is a schematic drawing showing a conventional 8*8-bit product.

FIG. 6A is a conventional DI AND gate circuit 600 obtained from the formulas 18 and 19.

FIG. 6B is a schematic drawing showing a conventional DI AND gate 602.

FIG. 7 is a schematic drawing showing a conventional single partial product generator scheme in a single row.

FIG. 8A is a schematic drawing showing a dual-rail symbol of a conventional DI full adder 800.

FIG. 8B is a schematic drawing showing a dual-rail symbol of a conventional DI full adder.

FIG. 9 is a schematic drawing showing a conventional DI carry look-ahead adder.

FIG. 10 is a schematic drawing showing a conventional Muller-C element with two inputs.

FIG. 11 is a schematic drawing showing a conventional Muller-C element with n inputs.

FIG. 12 is a schematic drawing showing a conventional n-bit completion detector.

FIG. 13 is a drawing showing an asynchronous multiplier with an accelerating circuit according to an embodiment of the present invention.

FIG. 14 is a schematic drawing showing an n-bit series delay insensitive (DI) leading-zero-bit detector according to an embodiment of the present invention.

FIG. 15 is a drawing showing a relation between effective bit lengths and delay time at different block size according to an embodiment of the present invention.

FIG. 16 is a schematic drawing showing a 1-bit zero adder gate level circuit according to an embodiment of the present invention.

FIG. 17 is a drawing showing an 8×8 left-to-right array multiplier with an accelerating circuit according to an embodiment of the present invention.

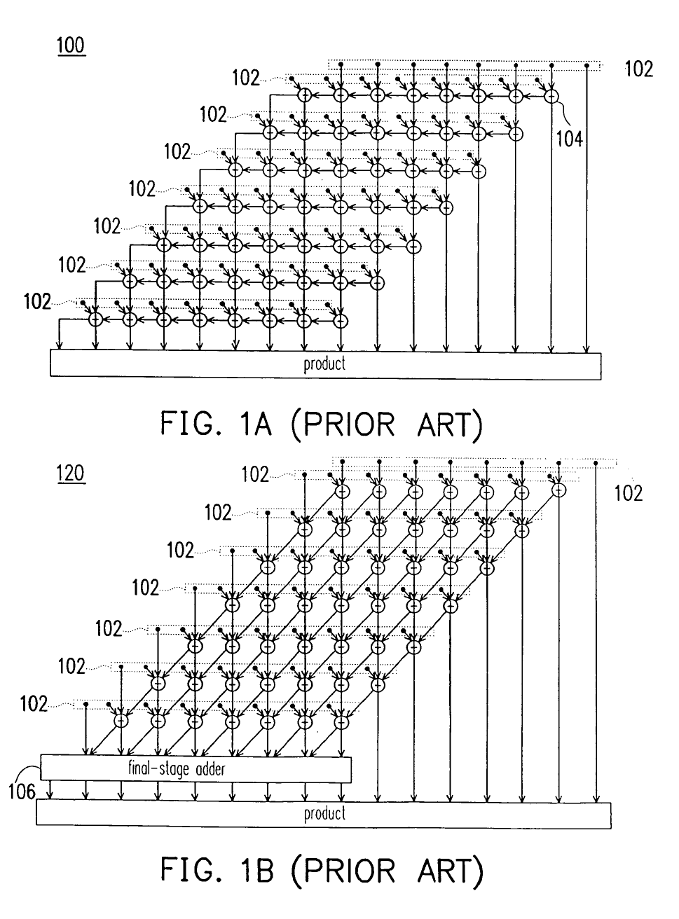

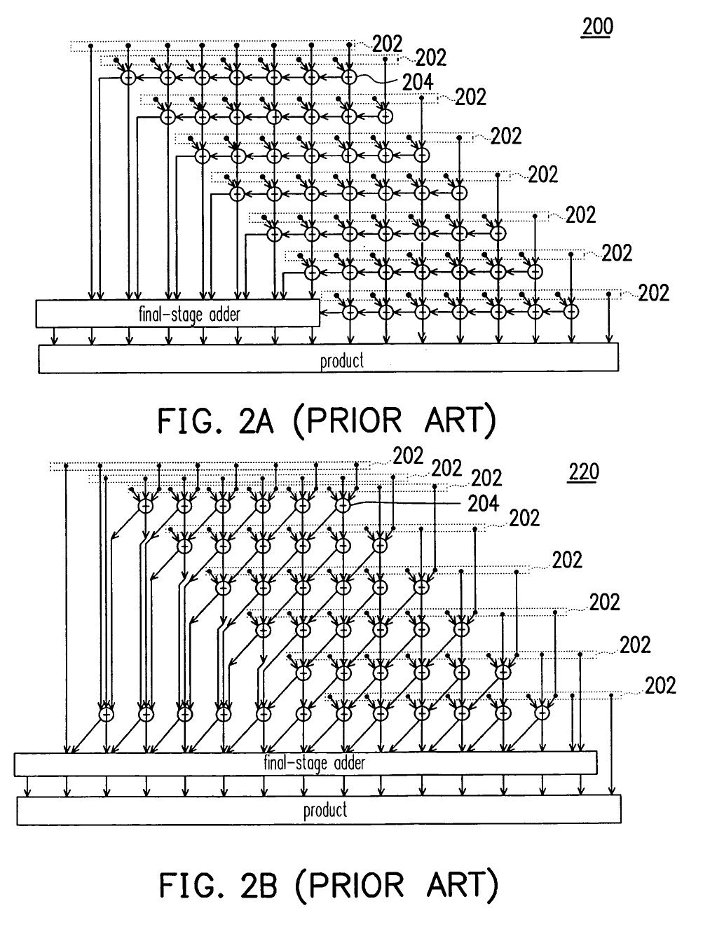

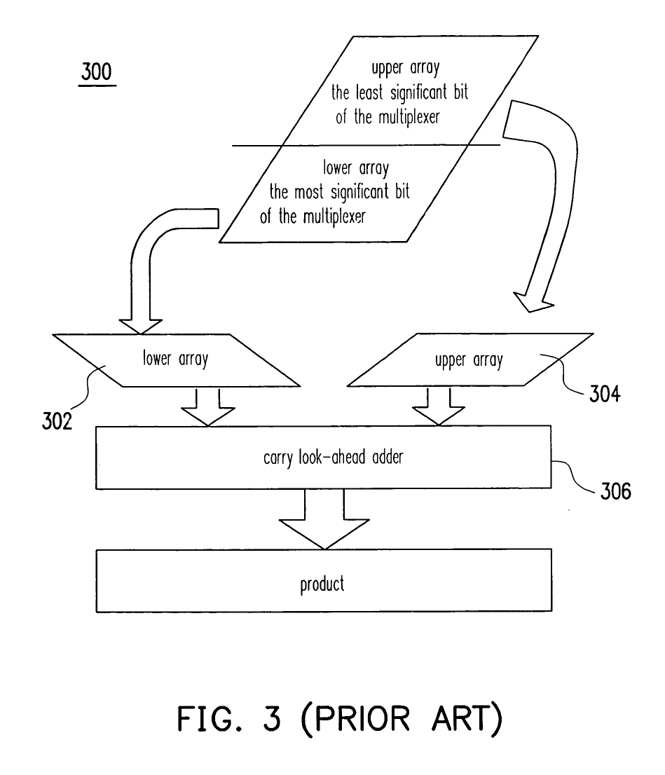

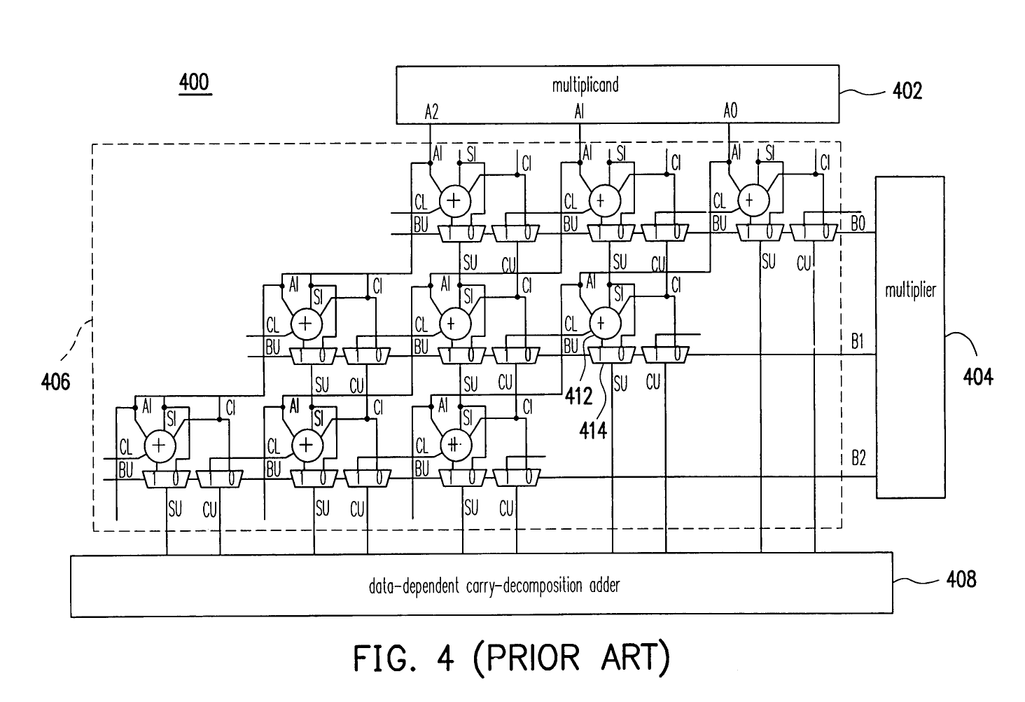

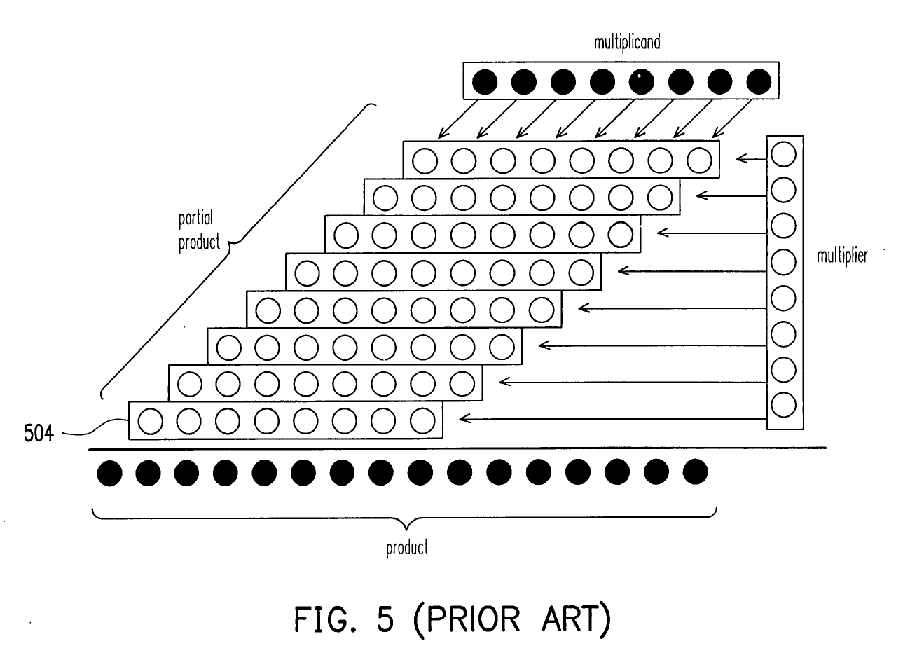

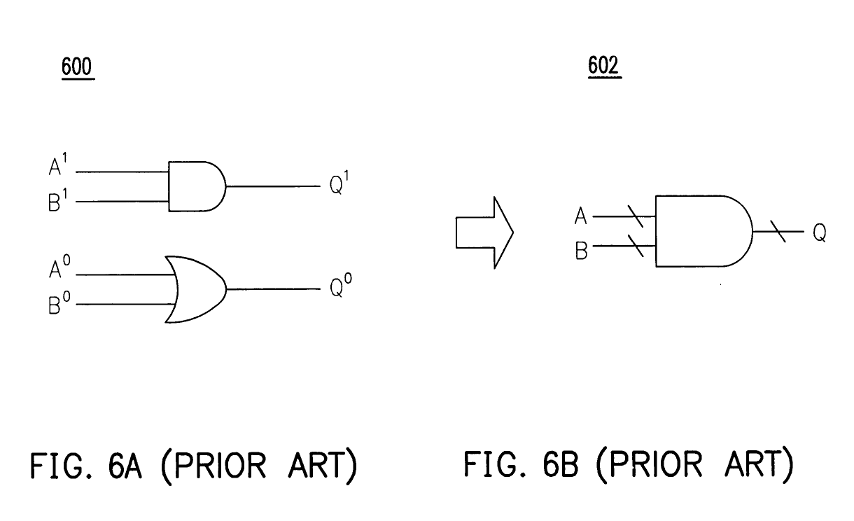

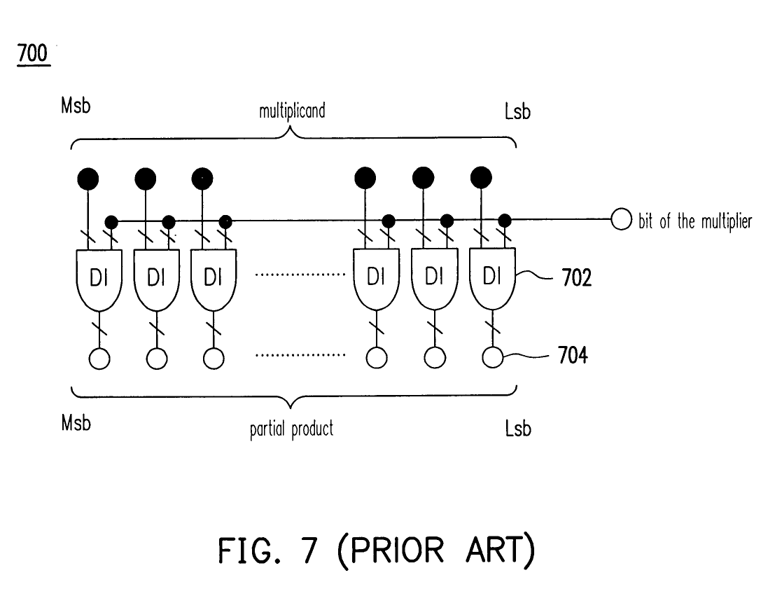

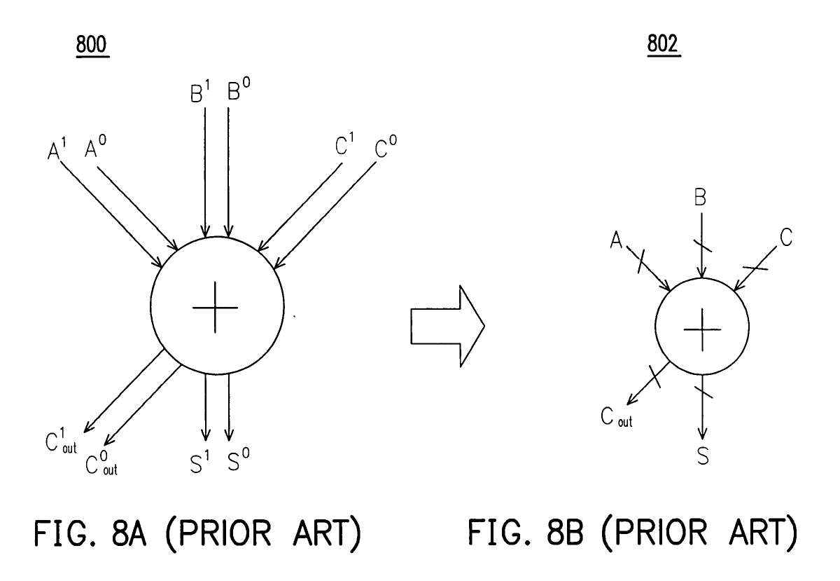

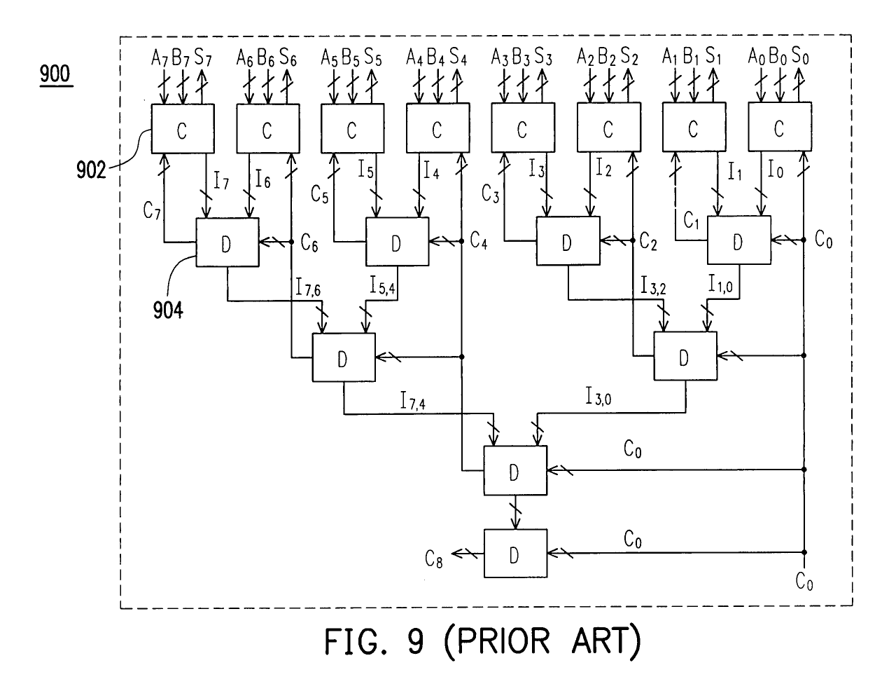

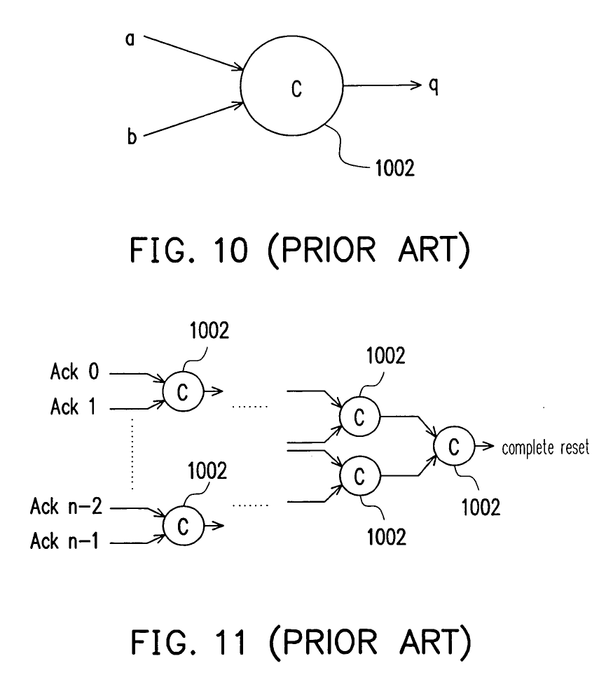

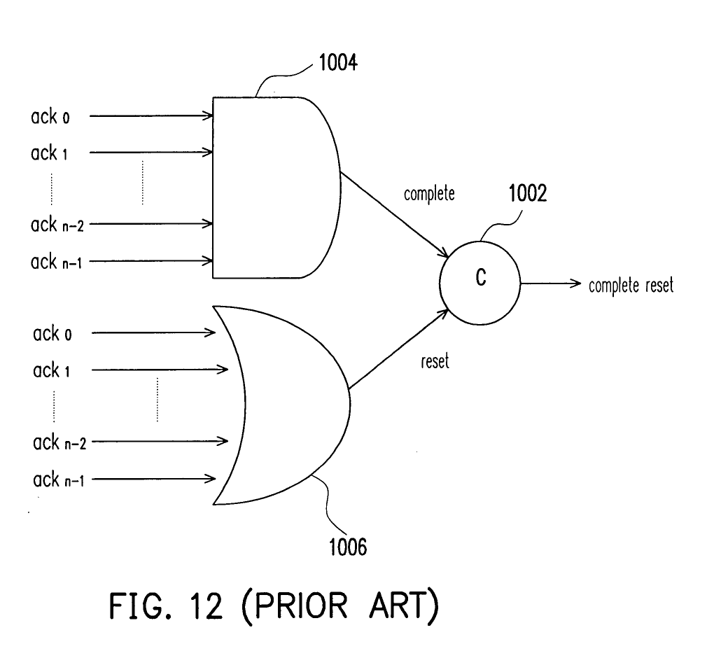

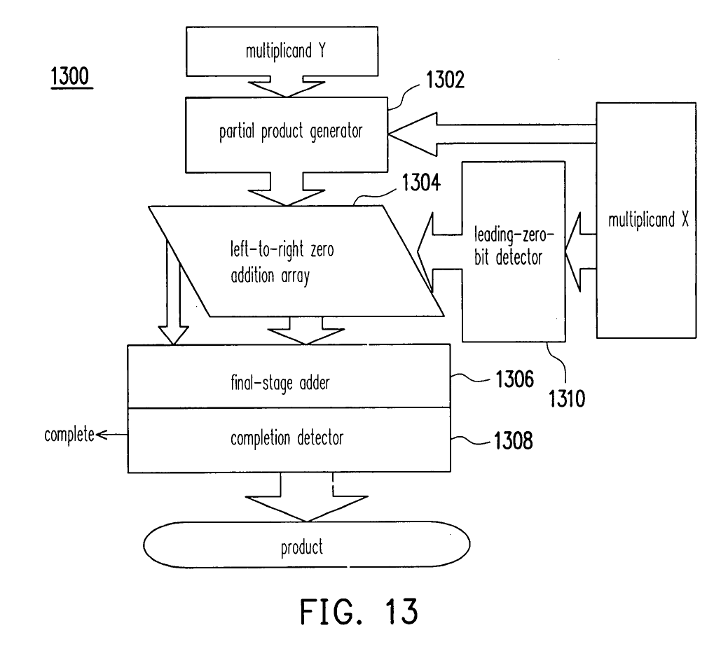

### DESCRIPTION OF SOME EMBODIMENTS

In this embodiment, the ineffective bit and the effective bit are defined to check each bit between the most significant bit (MSB) and the least significant bit (LSB) of the operand. If the bit is zero, the bit is defined as a ineffective bit, and the next bit is checked until a “1” bit is found. The bits between the “1” bit to the least significant bit are called effective bits. Their length is called effective length. In addition, the length of the ineffective bits is called ineffective length.

For example, for a 32×32 multiplication operation, if the multiplier and the multiplicand value in hexadecimal are 02E50FF0 and 00000D34, the ineffective bits are 6 bits and 20 bits, respectively. The effective bits are 26 bits and 12 bits, respectively.

In this embodiment, the accelerating circuit comprises a leading-zero-bit detector 1310 and a zero adder 1304.

The leading-zero-bit detector 1310 detects the effective bits and outputs the detection signals to the zero adder. The zero adder 1304, according to the detection signals, determines either to output zero or perform the addition operation. Wherein, the zero adder 1304 is used to constitute the addition array to replace the conventional addition array.

FIG. 13 is a drawing showing an asynchronous multiplier with an accelerating circuit according to an embodiment of the present invention. The asynchronous multiplier comprises a partial product generator 1302, a left-to-right addition array 1304, a leading-zero-bit detector 1310, a final-stage adder 1306, and a completion detector 1308.

In this embodiment, the leading-zero-bit detector 1310 can be, for example, a delay insensitive (DI) leading-zero-bit detector, which checks each bit between the most significant bit and the least significant bit of the multiplier. If a bit is zero, the zero-flag is 1. Then, a next bit is checked until a “1” bit is found. If the bit is 1, the corresponding zero-flag is 0, other bits of the multiplier need not be checked, and the remaining zero-flags are zero.

For example, when X¹=00010010, and X⁰=11101101, then Z¹=11100000 and Z⁰=00011111. When X¹=00000110 and X⁰=11111001, then Z¹=11111000 and Z⁰=00000111.

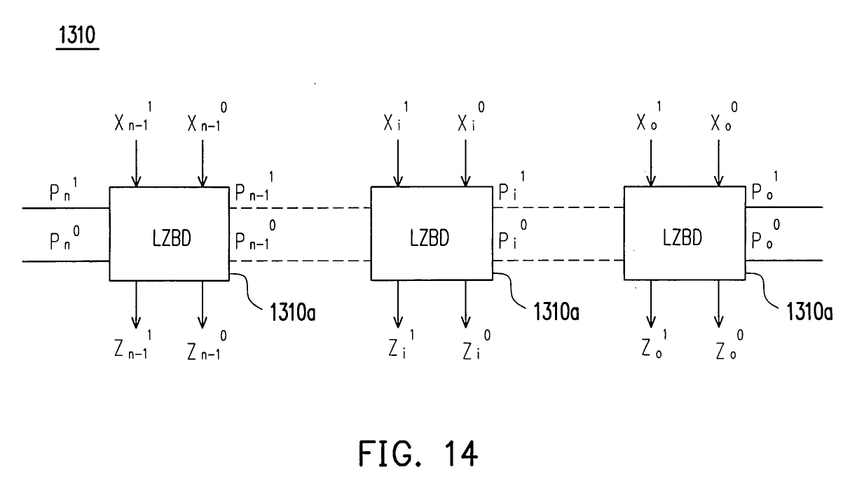

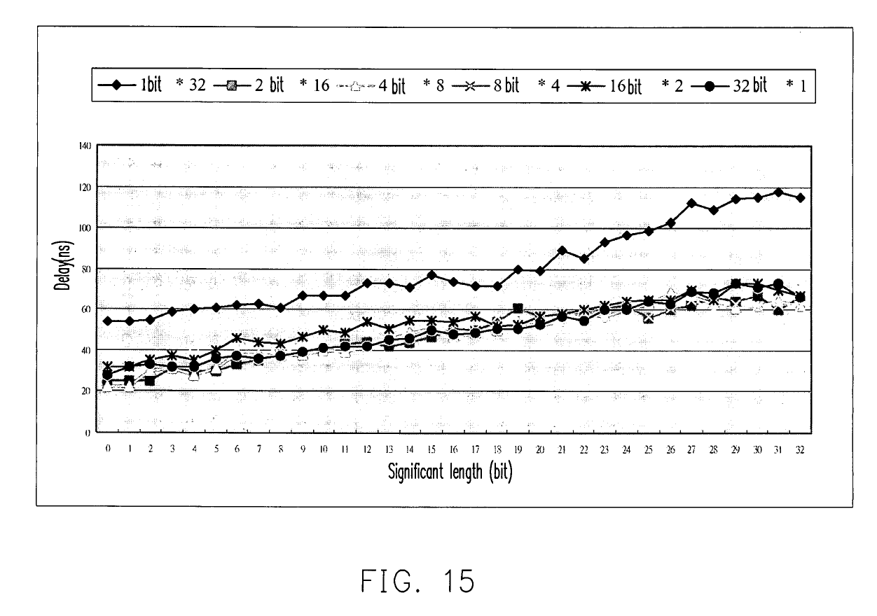

In order to execute the DI leading-zero-bit detector 1310, dual-rail signaling is used for inputting bits, zero-flags and zero-propagation. Accordingly, the 1-bit circuit can be defined as:
Zero-flag¹ Zᵢ¹=Pᵢ₊₁¹,Xᵢ⁰ (36)
Zero-flag⁰ Zᵢ⁰=Pᵢ₊₁¹Xᵢ¹+Pᵢ₊₁¹Xᵢ¹+Pᵢ₊₁⁰Xᵢ⁰ (37)
Zero- propagate¹ Pᵢ¹=Pᵢ₊₁¹X₁⁰ (38)
Zero-propagate⁰ Pᵢ⁰=Pᵢ₊₁¹Xᵢ¹+Pᵢ₊₁⁰Xᵢ¹+Pᵢ₊₁⁰Xᵢ⁰ (39)

Wherein, i=0, 1, . . . , n−1. FIG. 14 is a schematic drawing showing an n-bit series delay insensitive (DI) leading-zero-bit detector according to an embodiment of the present invention. Referring to FIG. 14, the n-bit delay insensitive (DI) leading-zero-bit detector 1310 comprises n 1-bit leading-zero-bit detectors 1310a coupled in series. The n-bit delay insensitive (DI) leading-zero-bit detector 1310 has an n-stage delay, but generates additional delays. The n-bit delay insensitive (DI) leading-zero-bit detector 1310 would simultaneously detect all inputs as much as possible. If n is a big number, the detection cannot work. The circuit would also become complicated, and great fan-in and fan-out would cause long delays.

In this embodiment, the n bits are divided into several blocks to solve the issue described above. Generally, a small block has a small area and a long delay. A small input, however, can make the computation and the result transmission speed to the next stage faster. On the contrary, a great block has a big area and a short delay. Additionally, a great block is accompanied with great fan-in and fan-out, but generates longer delays. Accordingly, the block size determines the area size and the delay time.

The delay is related to the effective length of simulation data. A longer effective length creates more delays. In other words, a shorter effective length results in a shorter delay. FIG. 15 is a drawing showing a relation between effective bit lengths and delay times at different block sizes according to an embodiment of the present invention.

Referring to FIG. 15, a 32×32-bit adder with an adder circuit is used in this embodiment. In this embodiment, the multiplier is set as 0xffffffff. The effective length of the multiplexer is variable from 0 bit to 32 bits. The best effective length is zero, because the multiplier is zero. Table 3 shows average delays measured in different block sizes.

TABLE 3

| | 1 bit * | 2 bits * | 4 bits * | 8 bits * | 16 bits * | 32 bits * |
|---|---|---|---|---|---|---|
| | 32 | 16 | 8 | 4 | 2 | 1 |
| Best | 0 | 0 | 0 | 0 | 0 | 0 |
| length | | | | | | |
| (bits) | | | | | | |
| Best | 54 | 25 | 22 | 31 | 32 | 28 |
| delay | | | | | | |
| (ns) | | | | | | |
| Worst | 32 | 31 | 27 | 31 | 31 | 30 |
| length | | | | | | |
| (bits) | | | | | | |
| Worst | 118 | 67 | 68 | 65 | 73 | 73 |
| delay | | | | | | |
| (ns) | | | | | | |
| Average | 80.3 | 48.0 | 47.7 | 49.3 | 53.6 | 49.7 |
| delay | | | | | | |
| (ns) | | | | | | |

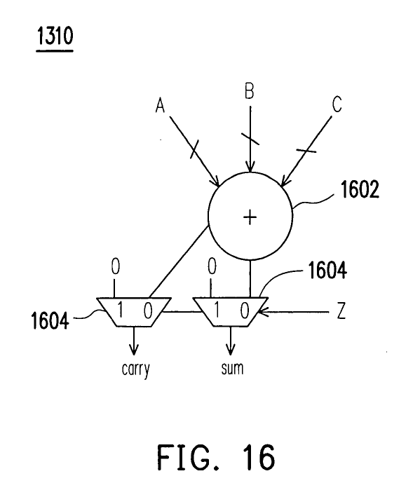

FIG. 16 is a schematic drawing showing a 1-bit zero adder gate level circuit according to an embodiment of the present invention. Referring to FIG. 16, the delay insensitive zero adder (DIZA) 1304 comprises a full adder 1602 and a multiplexer 1604, and is similar to a carry-select adder or a skip adder. The carry-select adder comprises a multiplexer to select an adder or pass an adder. A skip adder uses multiple inputs to skip several addition stages.

The leading-zero-bit detector 1310 generates a zero-flag Z. When Z is zero, the multiplexer 1604 selects and outputs an addition result. When Z is 1, the multiplexer 1604 does not need to wait for the operational result. The multiplexer 1604 immediately selects and outputs zero. The computation time is thus reduced.

In the DI zero adder 1304, the dual-rail signaling method is used to execute the DI full adder 1602 and the DI multiplexer 1604. The logic expression of the DI full adder 1604 can be shown as:
Carry⁰ Cᵢ₊₁⁰=Aᵢ⁰Bᵢ⁰+Aᵢ⁰Cᵢ⁰+Bᵢ⁰Cᵢ⁰ (40)
Carry¹ Cᵢ₊₁¹=Aᵢ¹Bᵢ¹+Aᵢ¹Cᵢ¹+Bᵢ¹Cᵢ¹ (41)
Sum⁰ Sᵢ⁰=Aᵢ⁰Bᵢ⁰Cᵢ⁰+Aᵢ⁰Bᵢ¹Cᵢ¹+Aᵢ¹Bᵢ⁰Cᵢ¹+Aᵢ¹Bᵢ¹Cᵢ⁰ (42)
Sum¹ Sᵢ¹=Aᵢ¹Bᵢ¹Cᵢ¹+Aᵢ¹Bᵢ⁰Cᵢ⁰+Aᵢ⁰Bᵢ¹Cᵢ⁰+Aᵢ⁰Bᵢ⁰Cᵢ¹ (43)

Wherein, Aᵢ and Bᵢ are main inputs of the adder 1602, and Cᵢ is the carry input of the adder 1602. In addition, Cᵢ₊₁ and Sᵢ are the output of the carry and the sum of the adder 1602. The carry bits are encoded with dual-rail signaling. If the formula 44 is equal to 1, it means no carry emerges from the last stage adder 1602. If the formula 45 is equal to 1, it means a carry emerges from the last stage adder 1602.

The DI zero adder 1304 comprises the DI adder 1602 and the DI multiplexer 1604. Its logic expression is shown as:
Carry⁰ Cᵢ₊₁⁰=Zᵢ⁰(Aᵢ⁰Bᵢ⁰+Aᵢ⁰Cᵢ⁰+Bᵢ⁰Cᵢ⁰)+Zᵢ¹(Eᵢ¹) (44)
Carry¹ Cᵢ₊₁¹=Zᵢ⁰(Aᵢ¹Bᵢ¹30 Aᵢ¹Cᵢ¹+Bᵢ¹Cᵢ¹)+Zᵢ¹(Eᵢ¹) (45)
Sum⁰ Sᵢ⁰=Zᵢ⁰(Aᵢ⁰Bᵢ⁰Cᵢ⁰+Aᵢ⁰Bᵢ¹Cᵢ¹+Aᵢ¹Bᵢ⁰Cᵢ¹+Aᵢ⁰Bᵢ⁰Cᵢ⁰)+Zᵢ¹(Eᵢ⁰) (46)
Sum¹ Sᵢ¹=Zᵢ⁰(Aᵢ¹Bᵢ¹Cᵢ¹+Aᵢ¹Bᵢ⁰Cᵢ⁰+Aᵢ⁰Bᵢ¹Cᵢ⁰+Aᵢ⁰Bᵢ⁰Cᵢ¹)+Zᵢ¹(Eᵢ¹) (47)

Wherein, Zᵢ represents the zero-flag from the corresponding leading-zero-bit detector 1310. If Eᵢ is always zero, Eᵢ¹=0, Eᵢ⁰=1. The equation described above can be simplified as:
Carry⁰ Cᵢ₊₁⁰=Zᵢ⁰(Aᵢ⁰Bᵢ⁰+Aᵢ⁰Cᵢ⁰+Bᵢ⁰Cᵢ⁰)+Zᵢ¹ (48)
Carry¹ Cᵢ₊₁¹=Zᵢ⁰(Aᵢ¹Bᵢ¹+Aᵢ¹Cᵢ¹+Bᵢ¹Cᵢ¹) (49)
Sum⁰ Sᵢ⁰=Zᵢ⁰(Aᵢ⁰Bᵢ⁰Cᵢ⁰+Aᵢ⁰Bᵢ¹Cᵢ¹+Aᵢ¹Bᵢ⁰Cᵢ¹+Aᵢ¹Bᵢ¹Cᵢ⁰)+Zᵢ¹ (50)
Sum¹ Sᵢ¹=Zᵢ⁰(Aᵢ¹Bᵢ¹Cᵢ¹+Aᵢ¹Bᵢ⁰Cᵢ⁰+Aᵢ⁰Bᵢ¹Cᵢ⁰+Aᵢ⁰Bᵢ⁰Cᵢ¹) (51)

After comparing the DI zero adder 1304 and the DI full adder 1602, the DI zero adder 1304 has more a smaller area, but can reduce the delay of the multiplier.

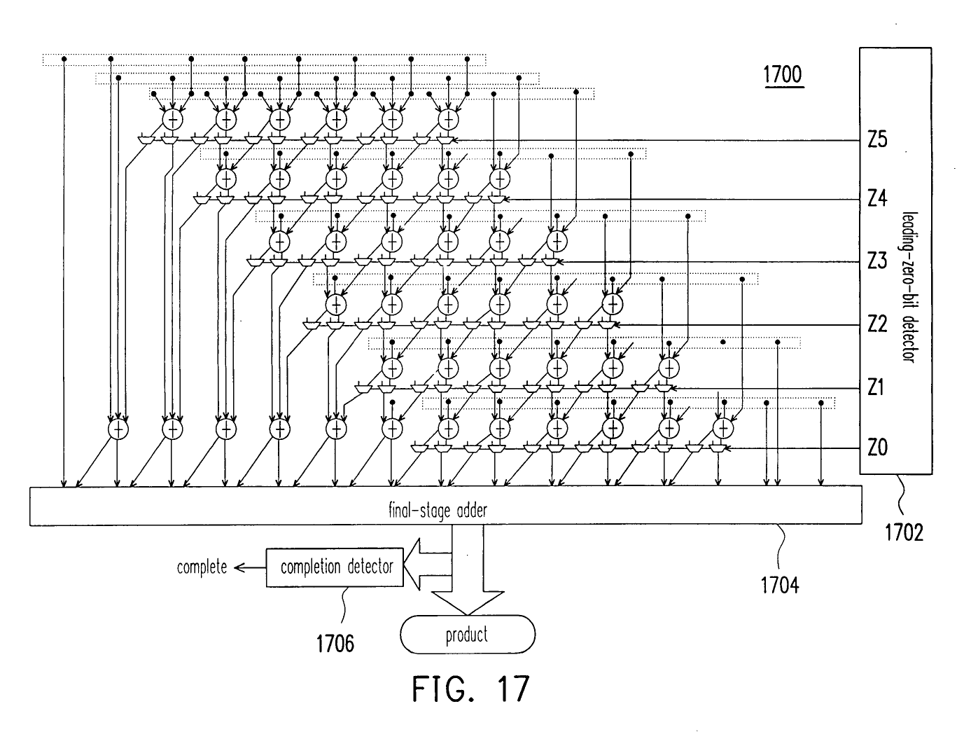

FIG. 17 is a drawing showing an 8×8 left-to-right array multiplier with an accelerating circuit according to an embodiment of the present invention. Compared with the conventional left-to-right multiplier, the left-to-right multiplier 1700 of the present invention comprises the DI leading-zero-bit detector 1702 and the DI zero adder 1708 to replace the DI adder. Accordingly, the left-to-right multiplier 1700 also comprises the final-stage adder 1704 and the completion detector 1706.

Referring to FIG. 17, the black dots represent partial products, wherein the products can be 0 or 1. Each square represents a single duplicate product of the multiplicand Y, wherein it is controlled by a particular bit of the multiplier (Xᵢ), and can be shown as:
Partial product: PPᵢ=Xᵢ*Y (52)

Wherein, i=0, 1 . . . , n−1. The sequence of the square from top to bottom is from PPₙ₋₁ to PP₀. Additionally, the first square PPₙ₊₁ represents the partial product of the most significant bit of the multiplier and the multiplicand Y.

The leading-zero-bit detector 1702 generates the zero flag (Zi), wherein i=0, 1 . . . n−3. Because the first row of the addition array is the sum of the first three rows of the partial products, n-2-bit flags are processed. In addition, the n−2 bits used for the zero-flags of the n-bit multiplier are generated. Each Zi controls a corresponding row of the addition array. If Zi=0, the multiplier of the corresponding row selects the addition for computation, and the sum vector and the carry vector are propagated to the next stage. When Zi=1, the multiplier of the corresponding row selects and outputs 0 to the next stage. For an n-bit multiplier, if the multiplier has m effective bits, m−3 stages of the addition rows are redundant. The m-row zero adder 1708 need not wait for the result in the final stage, and directly outputs zero. The m effective bits of the multiplier can reduce the m−2 stage computation time. Accordingly, only n-2-m stage computation time can be used to reach data dependence.

Accordingly, the asynchronous multiplier of the present invention divides the partial products into the effective bits and the ineffective bits. The ineffective bits, i.e., zero, is directly output to the final-stage adder to save the computation time and enhance the operational speed.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. An asynchronous multiplier, comprising:
a partial product generator generating a plurality of partial products according to a multiplier and a multiplicand;
an addition array coupled to the partial product generator, the addition array performing addition operation to the partial products;
a leading-zero-bit detector coupled to the addition array to detect an effective bit of the multiplier and an effective bit of the multiplicand, and to output a set of detection signals;
a final-stage adder coupled to the addition array to add the partial products and to output a sum; and
a completion detector coupled to the final-stage adder to check and output the result.

2. The asynchronous multiplier of claim 1, wherein the addition array comprises a plurality of zero adders coupled to the partial product generator and the leading-zero-bit detector, to determine either to output zero or perform the addition operation according to the set of the detection signals.

3. The asynchronous multiplier of claim 2, wherein the zero adder comprises:
a plurality of DI adders performing an addition operation to each bit of the partial products; and
a plurality of DI multiplexers coupled to the DI adders, determining either to output zero or perform the addition operation according to the set of the detection signals.

4. The asynchronous multiplier of claim 1, wherein each of the multiplier and the multiplicand comprises the effective bit and a ineffective bit.

5. The asynchronous multiplier of claim 1, wherein the multiplier is coupled to the leading-zero-bit detector.

6. The asynchronous multiplier of claim 5, wherein the leading-zero-bit detector detects each bit between a most significant bit and a least significant bit of the multiplier.

7. The asynchronous multiplier of claim 5, wherein a logic value of the most significant bit is 0.

8. The asynchronous multiplier of claim 1, wherein the addition array is a left-to-right addition array.
